(19) United States
(12) Patent Application Publication
(10) Pub. No.: US 2022/0027537 A1
(43) Pub. Date: Jan. 27, 2022

(54) MACHINE LEARNING DEVICE

(71) Applicant: Seiko Epson Corporation, Tokyo (JP)

(72) Inventor: Akihiko TSUNOYA, Okaya-shi (JP)

(21) Appl. No.: 17/381,732

(22) Filed: Jul. 21, 2021

(30) Foreign Application Priority Data
Jul. 23, 2020 (JP) 2020-125888

(51) Int. Cl. G06F 30/27; G06N 20/00

(52) U.S. Cl. CPC G06F 30/27; G06F 2113/10; G06N 20/00

(57) ABSTRACT

A machine learning device includes: a data acquisition unit configured to acquire first data including shape data representing a target shape of a three-dimensional shaped object and additional shape data representing a target shape of an additional portion to be added to the three-dimensional shaped object in order to prevent deformation of the three-dimensional shaped object during manufacturing, and second data related to the deformation of the three-dimensional shaped object; a storage unit configured to store a learning data set including a plurality of the first data and a plurality of the second data; and a learning unit configured to learn a relationship between the first data and the second data by executing machine learning using the learning data set.

The present application is based on, and claims priority from JP Application Serial Number 2020-125888, filed Jul. 23, 2020, the disclosure of which is hereby incorporated by reference herein in its entirety.

### BACKGROUND

### 1. Technical Field

The present disclosure relates to a machine learning device.

### 2. Related Art

A technique is known in which a material including powdered metal or ceramic is laminated to form a three-dimensional shaped object, and then the three-dimensional shaped object is sintered to increase strength. Since the three-dimensional shaped object shrinks due to sintering, the sintered three-dimensional shaped object may be distorted, cracked, warped, or the like. Regarding this problem, JP-T-2017-530027 discloses a technique that prevents deformation of the three-dimensional shaped object by predicting, using a finite element method, a deformation amount of the three-dimensional shaped object due to heat, correcting an input geometry when the predicted deformation amount is not within an allowable range, and shaping the three-dimensional shaped object according to the corrected input geometry.

In the technique of predicting the deformation amount of the three-dimensional shaped object using the finite element method as in JP-T-2017-530027, when the deformation amount due to the heat in the three-dimensional shaped object with a complicated shape such as that shaped by a three-dimensional shaping device is predicted, it is necessary to finely set a mesh of an analysis model, which increases analysis time. Such a problem is a common problem not only when the powdered metal or the like is laminated and then sintered to manufacture the three-dimensional shaped object, but also when a plasticized thermoplastic resin is laminated to manufacture the three-dimensional shaped object.

### SUMMARY

According to an aspect of the present disclosure, a machine learning device is provided. The machine learning device includes: a data acquisition unit configured to acquire first data including shape data representing a target shape of a three-dimensional shaped object and additional shape data representing a target shape of an additional portion to be added to the three-dimensional shaped object in order to prevent deformation of the three-dimensional shaped object during manufacturing, and second data related to the deformation of the three-dimensional shaped object; a storage unit configured to store a learning data set including a plurality of the first data and a plurality of the second data; and a learning unit configured to learn a relationship between the first data and the second data by executing machine learning using the learning data set.

### BRIEF DESCRIPTION OF THE DRAWINGS

FIG. 1 is an explanatory diagram showing a schematic configuration of a machine learning system according to a first embodiment.

FIG. 2 is an explanatory diagram showing a schematic configuration of a three-dimensional shaping device according to the first embodiment.

FIG. 3 is an explanatory diagram showing an example of a target shape of a three-dimensional shaped object.

FIG. 4 is a cross-sectional view taken along a line IV-IV of the three-dimensional shaped object of FIG. 3.

FIG. 5 is a flowchart showing a method of manufacturing a three-dimensional shaped object of the first embodiment.

FIG. 6 is a top view showing an example of the three-dimensional shaped object mounted on a setter.

FIG. 7 is a top view showing an example of a three-dimensional shaped object after a heat treatment step.

FIG. 8 is a first explanatory diagram showing a test result of examining quality of dimensional accuracy of the three-dimensional shaped object.

FIG. 9 is a top view showing a sample 2 mounted on the setter.

FIG. 10 is a second explanatory diagram showing a test result of examining the quality of the dimensional accuracy of the three-dimensional shaped object.

FIG. 11 is a top view showing a sample 8 mounted on the setter.

FIG. 12 is a flowchart showing contents of a learning processing of the first embodiment.

FIG. 13 is a flowchart showing contents of a prediction processing of the first embodiment.

FIG. 14 is an explanatory diagram showing a schematic configuration of a machine learning system according to a second embodiment.

FIG. 15 is a flowchart showing contents of a prediction processing of the second embodiment.

### DESCRIPTION OF EXEMPLARY EMBODIMENTS

### A. First Embodiment

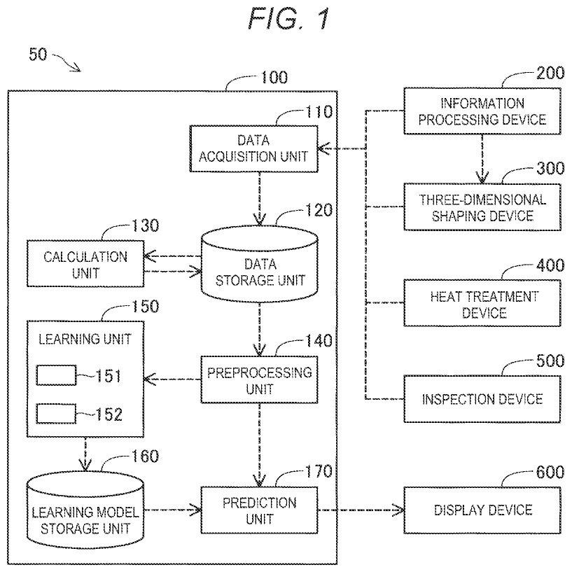

FIG. 1 is an explanatory diagram showing a schematic configuration of a machine learning system 50 according to a first embodiment. The machine learning system 50 includes a machine learning device 100, an information processing device 200, a three-dimensional shaping device 300, a heat treatment device 400, an inspection device 500, and a display device 600.

The machine learning device 100 is configured by a computer including one or a plurality of processors, a main storage device, and an input and output interface that inputs and outputs a signal to and from the outside. In the present embodiment, the machine learning device 100 generates a learning model by executing a learning processing to be described later, and predicts a manufacturing error of the three-dimensional shaped object using the learning model by executing a prediction processing to be described later. The machine learning device 100 may be configured by a plurality of computers.

In the present embodiment, the machine learning device 100 includes a data acquisition unit 110, a data storage unit 120, a calculation unit 130, a preprocessing unit 140, a learning unit 150, a learning model storage unit 160, and a prediction unit 170.

The data acquisition unit 110 acquires first data from the information processing device 200, the three-dimensional shaping device 300, and the heat treatment device 400 by wired communication or wireless communication. Further, the data acquisition unit 110 acquires second data from the inspection device 500 by the wire communication or the wireless communication. Details of the first data and the second data will be described later.

The data storage unit 120 stores various data such as the first data or the second data. The calculation unit 130 uses the first data and the second data, and generates manufacturing error data to be described later. The preprocessing unit 140 generates a learning data set using the first data and the manufacturing error data. In the learning processing, the learning unit 150 executes machine learning using the learning data set, and generates a learning model. In the present embodiment, the learning unit 150 includes a reward calculation unit 151 and a value function update unit 152. The learning model storage unit 160 stores the learning model. In the prediction processing, the prediction unit 170 predicts the manufacturing error of the three-dimensional shaped object using the learning model.

The information processing device 200 is configured by a computer including one or a plurality of processors, a main storage device, and an input and output interface that inputs and outputs a signal to and from the outside. In the present embodiment, the information processing device 200 generates shape data and additional shape data by three-dimensional CAD software installed in advance. The shape data represents a target shape of a main body portion of the three-dimensional shaped object. The additional shape data represents a target shape of an additional portion added to the main body portion in order to prevent deformation of the main body portion during manufacture of the three-dimensional shaped object. The target shape means a shape that is targeted at a time of manufacturing a product. That is, when the product is manufactured according to the target shape, the manufacturing error of the product is zero. When target shapes or sizes between the main body portion of a product A and the main body portion of a product B are different, target shapes of both the main body portions are different. Further, when target shapes, sizes, the numbers, or arrangement with respect to the main body portions are different between the additional portion of the product A and the additional portion of the product B, target shapes of both the additional portions are different. The shape data and the additional shape data are transmitted to the machine learning device 100. Further, in the present embodiment, the information processing device 200 generates shaping data by slicer software installed in advance reading the shape data and the additional shape data. The shaping data represents various types of information for controlling the three-dimensional shaping device 300 such that the three-dimensional shaped object having a desired shape is shaped. The shaping data is transmitted to the three-dimensional shaping device 300.

The three-dimensional shaping device 300 shapes the three-dimensional shaped object according to the shaping data. In the present embodiment, the three-dimensional shaping device 300 is a binder jet type three-dimensional shaping device. A configuration of the three-dimensional shaping device 300 will be described later.

The heat treatment device 400 heat-treats the three-dimensional shaped object shaped by the three-dimensional shaping device 300. In the present embodiment, the heat treatment device 400 is a sintering furnace. The heat treatment device 400 sinters the three-dimensional shaped object according to predetermined heat treatment conditions. The heat treatment conditions include, for example, a heating time, or a heating temperature.

The inspection device 500 measures a dimension of the three-dimensional shaped object after the heat treatment and generates measurement data. In the present embodiment, the inspection device 500 is a three-dimensional measuring machine. In the present embodiment, the measurement data represents a shape of the three-dimensional shaped object after the heat treatment. The measurement data may represent an amount of strain, an amount of warpage, presence or absence of a crack, or the like of the three-dimensional shaped object after the heat treatment.

The display device 600 displays a prediction result of the prediction unit 170 of the machine learning device 100. In the present embodiment, the display device is a liquid crystal display. The display device 600 is not limited to the liquid crystal display, and may be, for example, a plasma display or an organic EL display.

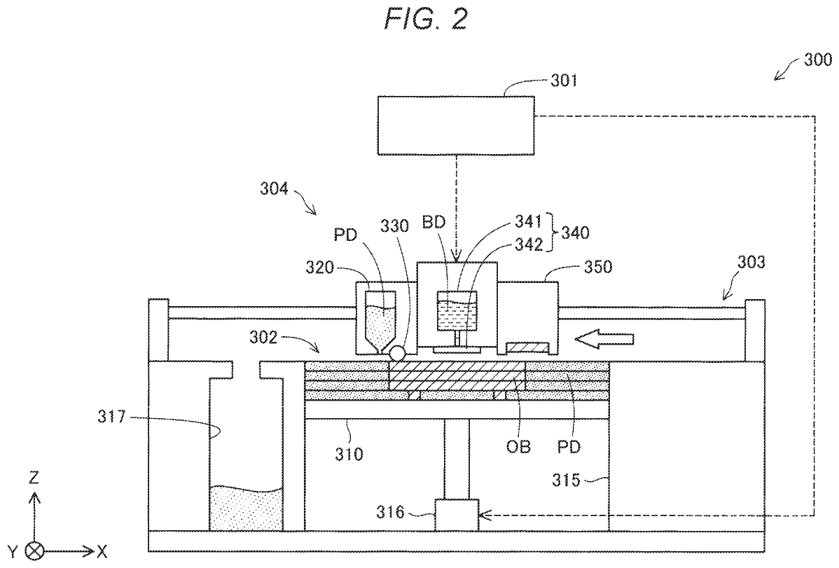

FIG. 2 is an explanatory diagram showing a schematic configuration of the three-dimensional shaping device 300. The three-dimensional shaping device 300 includes a control unit 301, a table unit 302, a moving mechanism 303, and a shaping unit 304. The control unit 301 is configured by a computer including one or a plurality of processors, a main storage device, and an input and output interface that inputs and outputs a signal to and from the outside. The control unit 301 controls the table unit 302, the moving mechanism 303, and the shaping unit 304 according to the shaping data supplied by the information processing device 200.

The table unit 302 includes a table 310, a frame body 315 surrounding an outer periphery of the table 310, and a lifting mechanism 316 that moves the table 310 along a Z-direction. In the present embodiment, the lifting mechanism 316 is configured by an actuator that moves the table 310 along the Z-direction under control of the control unit 301.

The moving mechanism 303 is provided above the table unit 302. The moving mechanism 303 supports the shaping unit 304, and relatively moves the shaping unit 304 relative to the table 310 along an X-direction. In the present embodiment, the moving mechanism 303 is configured by an actuator that moves the shaping unit 304 along the X-direction under the control of the control unit 301.

The shaping unit 304 is disposed above the table unit 302. The shaping unit 304 includes a material supply unit 320, a flattening unit 330, a liquid supply unit 340, and a curing energy supply unit 350. In the shaping unit 304, the material supply unit 320, the flattening unit 330, the liquid supply unit 340, and the curing energy supply unit 350 are arranged in this order from an −X-direction side.

The material supply unit 320 supplies a powder material PD, which is a powdered material, onto the table 310. In the present embodiment, the material supply unit 320 is configured by a hopper that stores the powder material PD. The powder material PD is a raw material for a three-dimensional shaped object. As the powder material PD, a powder of a metal material such as a stainless steel, a steel other than the stainless steel, a pure iron, a titanium alloy, a magnesium alloy, a cobalt alloy, or a nickel alloy, a powder of a ceramic material such as silicon dioxide, titanium dioxide, aluminum oxide, zirconium oxide, silicon nitride, or the like can be used. One type of these materials may be used as the powder material PD, or two or more types of these materials may be combined and used as the powder material PD. In the present embodiment, powder of stainless steel is used as the powder material PD.

The flattening unit 330 flattens the powder material PD supplied onto the table 310 from the material supply unit 320. In the present embodiment, the flattening unit 330 is configured by a roller. An excess powder material PD extruded from the table 310 by the flattening unit 330 is accommodated in a material recovery unit 317 provided in the frame body 315. The flattening unit 330 may be configured by a squeegee.

The liquid supply unit 340 includes a liquid supply source 341 that is a supply source of a binding liquid BD, and a liquid injection head 342 that injects the binding liquid BD onto the powder material PD flattened by the flattening unit 330. In the present embodiment, the liquid supply source 341 is configured by a tank that stores the binding liquid BD. The binding liquid BD is a liquid including a binder that binds the powder materials PDs to each other. As the binder, a thermoplastic resin, a thermosetting resin, an X-ray curable resin, and various photocurable resins such as a visible photocurable resin that is cured by light in a visible light region, an ultraviolet curable resin, and an infrared curable resin, or the like can be used. One type of these resins may be used as the binder, or two or more types of these resins may be combined and used as the binder. Water or an organic solvent can be used as a solvent for the binder. In the present embodiment, the binding liquid BD including an ultraviolet curable resin is used as the binder.

The liquid injection head 342 is configured by a piezo-driven liquid injection head including a pressure chamber, a piezo element that changes a volume of the pressure chamber, and a plurality of nozzle holes communicating with the pressure chamber. The liquid injection head 342 reduces the volume of the pressure chamber by bending, by the piezo element, a side wall of the pressure chamber filled with the binding liquid supplied from the liquid supply source 341, and injects an amount of binding liquid BD corresponding to a volume reduction amount of the pressure chamber from the nozzle holes.

The curing energy supply unit 350 applies energy for curing the binder to the binder included in the binding liquid BD injected from the liquid supply unit 340 to the powder material PD. In the present embodiment, the curing energy supply unit 350 is configured by an ultraviolet lamp. When a thermosetting binder is used, the curing energy supply unit 350 may be configured by a heater.

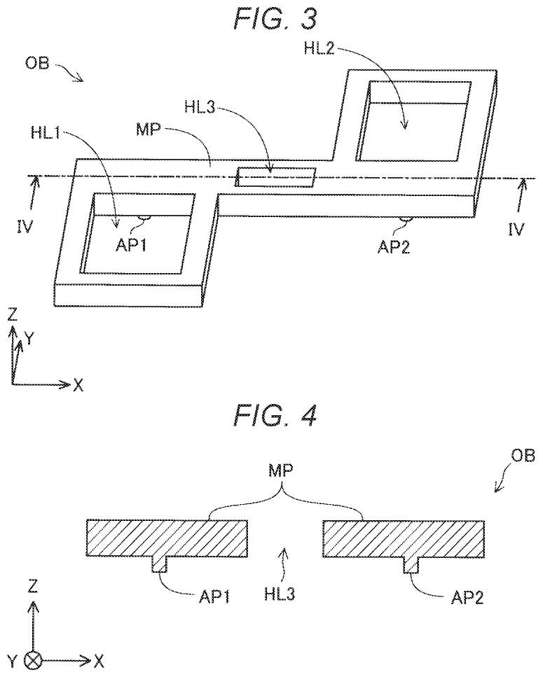

FIG. 3 is an explanatory diagram showing an example of a target shape of a three-dimensional shaped object OB. FIG. 4 is a cross-sectional view of the three-dimensional shaped object OB taken along a line IV-IV in FIG. 3. The three-dimensional shaped object OB shown in FIGS. 3 and 4 includes a main body portion MP and two additional portions AP1 and AP2. In the following description, the additional portion AP1 is referred to as a first additional portion AP1, and the additional portion AP2 is referred to as a second additional portion AP2. When the first additional portion AP1 and the second additional portion AP2 are described without particular distinction, the first additional portion AP1 and the second additional portion AP2 may be simply referred to as additional portions AP. In this example, the main body portion MP has a Z-shaped outer shape when viewed from above. A first through hole HL1 is provided in one end portion of the main body portion MP, a second through hole HL2 is provided in the other end portion of the main body portion MP, and a third through hole HL3 is provided in a central portion of the main body portion MP. The first additional portion AP1 and the second additional portion AP2 have a cylindrical shape centered on a central axis along the Z-direction. The first additional portion AP1 and the second additional portion AP2 are coupled to a bottom surface of the main body portion MP. The first additional portion AP1 is disposed adjacent to the first through hole HL1, and the second additional portion AP2 is disposed adjacent to the second through hole HL2. The first additional portion AP1 and the second additional portion AP2 are disposed so as to sandwich the third through hole HL3.

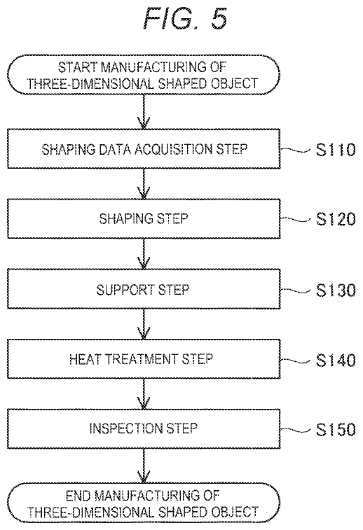

FIG. 5 is a flowchart showing a method of manufacturing the three-dimensional shaped object OB in the present embodiment. A method of manufacturing the three-dimensional shaped object OB will be described by taking as an example a state in which the three-dimensional shaped object OB shown in FIGS. 3 and 4 is manufactured. First, in a shaping data acquisition step of step S110 of FIG. 5, the control unit 301 of the three-dimensional shaping device 300 acquires the shaping data from the information processing device 200.

In a shaping step of step S120, as shown in FIG. 2, the control unit 301 shapes, according to the shaping data, the three-dimensional shaped object OB on the table 310 by controlling the shaping unit 304, the moving mechanism 303, and the lifting mechanism 316 of the table unit 302. In an initial state, the shaping unit 304 is disposed on a +X-direction side of the table 310. The control unit 301 moves the shaping unit 304 in a −X-direction by controlling the moving mechanism 303. The control unit 301 supplies the powder material PD from the material supply unit 320 onto the table 310 while moving the shaping unit 304 in the −X-direction, flattens, by the flattening unit 330, the powder material PD supplied on the table 310, injects the binding liquid BD from the liquid supply unit 340 at a position on the powder material PD corresponding to the target shape of the three-dimensional shaped object OB, and cures the binder included in the binding liquid BD by the curing energy supply unit 350. By curing the binder, an nth layer of the three-dimensional shaped object OB is formed. n is an optional natural number. Thereafter, the control unit 301 returns the shaping unit 304 to a position on the +X-direction side of the table 310 by controlling the moving mechanism 303, and lowers the table 310 by a thickness of the nth layer by controlling the lifting mechanism 316. By repeating the above processing, the control unit 301 laminates an (n+1)th layer on the nth layer, and shapes the three-dimensional shaped object OB including the main body portion MP and each of the additional portions AP1 and AP2.

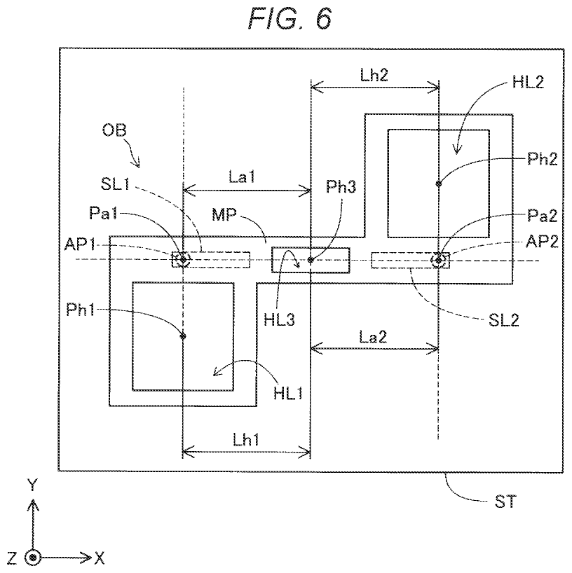

FIG. 6 is a top view showing an example of the three-dimensional shaped object OB mounted on a setter ST. In a support step of step S130 of FIG. 5, the three-dimensional shaped object OB is taken out from the three-dimensional shaping device 300 and mounted on the setter ST as shown in FIG. 6. The setter ST is a plate-shaped member made of a ceramic material or the like. In this example, the setter ST is provided with two slits SL1 and SL2. In the following description, the slit SL1 is referred to as a first slit SL1, and the slit SL2 is referred to as a second slit SL2. When the first slit SL1 and the second slit SL2 are described without particular distinction, the first slit SL1 and the second slit SL2 may be simply referred to as the slit SL. The first slit SL1 and the second slit SL2 have longitudinal directions along the X-direction. The three-dimensional shaped object OB is mounted on the setter ST such that the first additional portion AP1 provided on the three-dimensional shaped object OB is inserted into the first slit SL1 and the second additional portion AP2 is inserted into the second slit SL2.

In a heat treatment step of step S140 in FIG. 5, the three-dimensional shaped object OB is subjected to a heat treatment. In the present embodiment, the heat treatment device 400 degreases the binder from the three-dimensional shaped object OB, and further sinters the three-dimensional shaped object OB by heating the three-dimensional shaped object OB in a state of being mounted on the setter ST under predetermined heat treatment conditions. By the sintering, the three-dimensional shaped object OB shrinks, and strength of the three-dimensional shaped object OB increases.

In an inspection step of step S150, the inspection device 500 measures the dimension of the three-dimensional shaped object OB after the heat treatment step, and generates the measurement data. The measurement data is transmitted to the machine learning device 100. After step S150, the method of manufacturing the three-dimensional shaped object OB is completed. Each of the additional portions AP1 and AP2 is removed from the three-dimensional shaped object OB between the heat treatment step of step S140 and the inspection step of step S150, or after the heat treatment step of step S150.

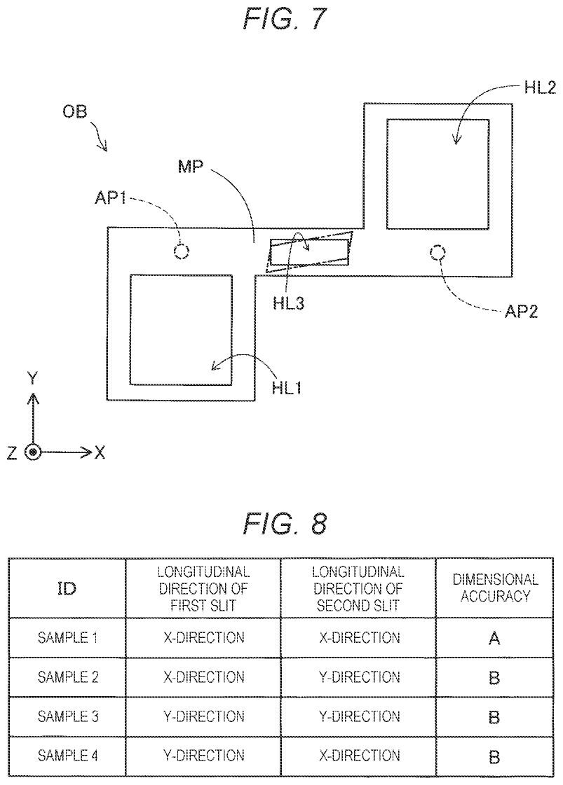

FIG. 7 is a top view showing an example of the three-dimensional shaped object OB after the heat treatment step. FIG. 7 shows the three-dimensional shaped object OB after the heat treatment step using the setter ST shown in FIG. 6. In this example, since the first slit SL1 restricts a movement of the first additional portion AP1 along a Y-direction and the second slit SL2 restricts a movement of the second additional portion AP2 along the Y-direction, a moment of a force centered on the central axis along the Z-direction, which is caused by shrinkage of the three-dimensional shaped object OB in the heat treatment step, is prevented from acting on an outer peripheral portion of the third through hole HL3 in the main body portion MP. Therefore, deformation of the outer peripheral portion of the third through hole HL3 is prevented.

When the shape, the size or the arrangement of each of the additional portions AP1 and AP2 of the three-dimensional shaped object OB, or the shape, the size or the arrangement of each of the slits SL1 and SL2 of the setter ST is not appropriate, for example, the moment of the force centered on the central axis along the Z-direction acts, and as shown by an alternate long and short dash line in FIG. 7, a shape of the outer peripheral portion of the third through hole HL3 collapses, and a manufacturing error of the main body portion MP of the three-dimensional shaped object OB may exceed the allowable range.

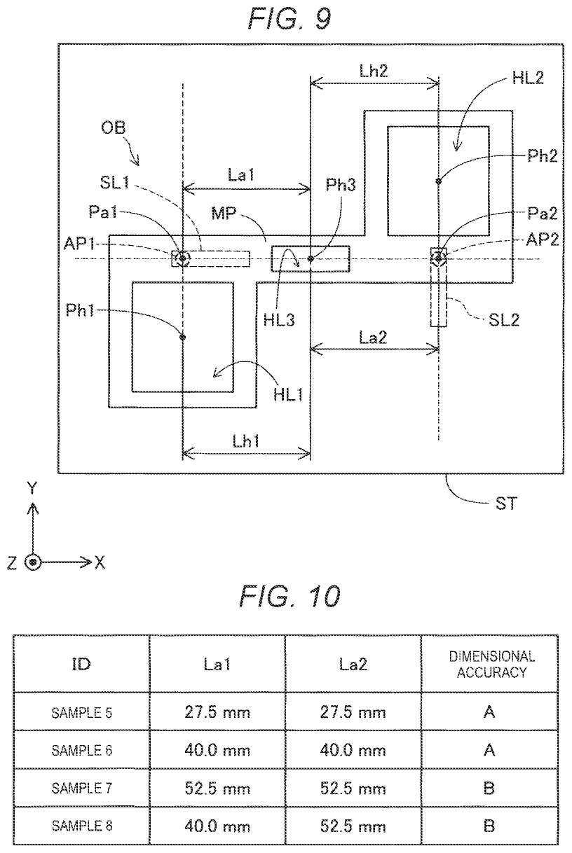

FIG. 8 is a first explanatory diagram showing a test result of examining quality of dimensional accuracy of the three-dimensional shaped object OB. FIG. 9 is a top view showing a sample 2 mounted on the setter ST. FIG. 8 shows a result of examining the dimensional accuracy of the main body portion MP for four samples 1 to 4 of the three-dimensional shaped object OB manufactured by differently orientating the longitudinal directions of the slits SL1 and SL2 of the setter ST. For each of the samples 1 to 4, when the manufacturing error of the main body portion MP is within the allowable range, in other words, when the dimensional accuracy of the main body portion MP is good, a symbol “A” is attached. When the manufacturing error of the main body portion MP exceeds the allowable range, in other words, when the dimensional accuracy of the main body portion MP is not good, a symbol “B” is attached.

The shapes, materials, and heat treatment conditions of each of the sample 1 to 4 are the same. In manufacture of the sample 1, as shown in FIG. 6, the heat treatment step was performed using a setter ST in which the first slit SL1 and the second slit SL2 have the longitudinal directions along the X-direction. In manufacture of the sample 2, as shown in FIG. 9, the heat treatment step was performed using a setter ST in which the first slit SL1 has the longitudinal direction along the X-direction, and the second slit SL2 has the longitudinal direction along the Y-direction. In manufacture of the sample 3, the heat treatment step was performed using the setter ST in which the first slit SL1 and the second slit SL2 have the longitudinal directions along the Y-direction. In manufacture of the sample 4, the heat treatment step was performed using a setter ST in which the first slit SL1 has the longitudinal direction along the Y-direction, and the second slit SL2 has the longitudinal direction along the X-direction. The manufacturing error of the main body portion MP of the sample 1 was within the allowable range. On the other hand, manufacturing errors of the main body portions MPs of the samples 2 to 4 exceeded the allowable range.

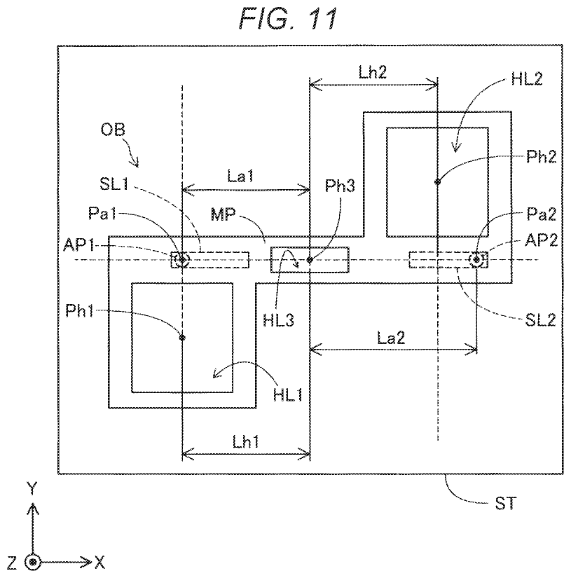

FIG. 10 is a second explanatory diagram showing a test result of examining the quality of the dimensional accuracy of the three-dimensional shaped object OB. FIG. 11 is a top view showing a sample 8 mounted on the setter ST. FIG. 10 shows a result of examining the dimensional accuracy of the main body portion MP for four samples 5 to 8 of the three-dimensional shaped object OB manufactured by differently arranging each of the additional portions AP1 and AP2. Meanings of the symbols “A” and “B” attached to indicate the quality of the dimensional accuracy in FIG. 10 are the same as the meanings of the symbols “A” and “B” attached to indicate the quality of the dimensional accuracy in FIG. 8.

The materials and the heat treatment conditions of the sample 5 to 8 are the same. In manufacture of each of the samples 5 to 8, the heat treatment step was performed using a setter ST in which the first slit SL1 and the second slit SL2 have the longitudinal directions along the X-direction. In each of the samples 5 to 8, a center point Pa1 of the first additional portion AP1, a center point Ph3 of the third through hole HL3, and a center point Pa2 of the second additional portion AP2 are arranged in this order along the X-direction. In each of the samples 5 to 8, a position of the center point Pa1 of the first additional portion AP1 in the Y-direction, a position of the center point Ph3 of the third through hole HL3 in the Y-direction, and a position of the center point Pa2 of the second additional portion AP2 in the Y-direction are the same. In each of the samples 5 to 8, a distance Lh1 along the X-direction between the center point Ph1 of the first through hole HL1 and the center point Ph3 of the third through hole HL3 is 40.0 mm, and a distance Lh2 along the X-direction between the center point Ph2 of the second through hole HL2 and the center point Ph3 of the third through hole HL3 is 40.0 mm.

In the sample 5, a distance La1 along the X-direction between the center point Pa1 of the first additional portion AP1 and the center point Ph3 of the third through hole HL3 is 27.5 mm, and a distance La1 along the X-direction between the center point Pa2 of the second additional portion AP2 and the center point Ph3 of the third through hole HL3 is 27.5 mm. In the sample 6, the distance La1 along the X-direction between the center point Pa1 of the first additional portion AP1 and the center point Ph3 of the third through hole HL3 is 40.0 mm, and the distance La2 along the X-direction between the center point Pa2 of the second additional portion AP2 and the center point Ph3 of the third through hole HL3 is 40.0 mm. That is, in the sample 6, the first additional portion AP1 and the second additional portion AP2 are arranged as shown in FIG. 6. In the sample 7, the distance La1 along the X-direction between the center point Pa1 of the first additional portion AP1 and the center point Ph3 of the third through hole HL3 is 52.5 mm, and the distance La2 along the X-direction between the center point Pa2 of the second additional portion AP2 and the center point Ph3 of the third through hole HL3 is 52.5 mm. In the sample 8, the distance La1 along the X-direction between the center point Pa1 of the first additional portion AP1 and the center point Ph3 of the third through hole HL3 is 40.0 mm, and the distance La2 along the X-direction between the center point Pa2 of the second additional portion AP2 and the center point Ph3 of the third through hole HL3 is 52.5 mm. That is, in the sample 8, the first additional portion AP1 and the second additional portion AP2 are arranged as shown in FIG. 11. The manufacturing errors of the main body portions MPs of the samples 5 and 6 were within the allowable range. On the other hand, the manufacturing errors of the main body portions MPs of the samples 7 and 8 exceeded the allowable range.

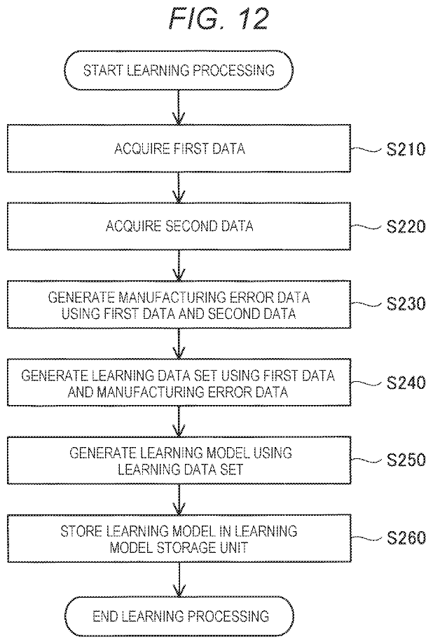

FIG. 12 is a flowchart showing contents of the learning processing. This processing is executed by the machine learning device 100, for example, at a timing when the manufacture of one three-dimensional shaped object OB is completed. First, in step S210, the data acquisition unit 110 acquires the first data. The first data includes the shape data representing the target shape of the main body portion MP of the three-dimensional shaped object OB and the additional shape data representing the target shape of the additional portion AP. In the present embodiment, the first data further includes material data representing information about the material used in the shaping step and heat treatment condition data representing the heat treatment conditions in the heat treatment step. The material data represents, for example, a type, physical properties, a particle size, or the like of the powder material PD. When two or more types of materials are combined and used as the powder material PD, the type, the physical properties, the particle size of each material, and content of each material in the powder material PD may be represented. The material data may further represent a type or physical properties of the binding liquid, content of the binder, or the like. The heat treatment condition data represents, for example, the position or the orientation of the longitudinal direction of the slit SL of the setter ST used in the heat treatment step, the heating time, the heating temperature, a heating rate, the number of beatings, or the like in the heat treatment step. The acquired first data is stored in the data storage unit 120.

In step S220, the data acquisition unit 110 acquires the second data. The second data includes the measurement data generated in the inspection step. In the present embodiment, the measurement data represents the shape of the three-dimensional shaped object OB after the heat treatment step. The acquired second data is associated with the corresponding first data and stored in the data storage unit 120. An order of the processing in step S210 and the processing in step S220 may be reversed.

In step S230, the calculation unit 130 reads the first data and the second data stored in the data storage unit 120, and generates the manufacturing error data representing an error between the dimension of the shape of the three-dimensional shaped object OB after the heat treatment step and the dimension of the target shape. The generated manufacturing error data is stored in the data storage unit 120. In step S240, the preprocessing unit 140 reads the first data stored in the data storage unit 120 and the manufacturing error data associated with the first data, and generates the learning data set.

In step S250, the learning unit 150 reads the learning data set generated by the preprocessing unit 140, executes the machine learning, and generates the learning model. In step S260, the learning model storage unit 160 stores the learning model generated by the learning unit 150. Thereafter, the machine learning device 100 ends this processing. The machine learning device 100 uses the learning data set including data on the target shape of the main body portion MP, the target shape of the additional portion AP, or a plurality of three-dimensional shaped objects OB in which the powder materials PDs, the heat treatment conditions, or the like are different, executes the machine learning, and updates the learning model by repeating this processing every time the manufacture of one three-dimensional shaped object OB is completed. For example, the machine learning device 100 uses learning data set including data on a plurality of three-dimensional shaped objects OB in which the orientations of the longitudinal direction of the slit SL of the setter ST, that is, the heat treatment conditions are different as in the samples 1 to 4 described above, or including data on a plurality of three-dimensional shaped objects OB in which the target shapes of the additional portion AP are different as in the samples 5 to 8 described above, executes the machine learning, and updates the learning model.

An algorithm of the machine learning executed by the learning unit 150 in step S250 described above is not particularly limited, and for example, known algorithms of such as supervised learning, unsupervised learning, reinforcement learning can be adopted. In the present embodiment, the learning unit 150 executes reinforcement learning to be described later. The reinforcement learning is a method of repeating a cycle by trial and error in which a predetermined action is performed in a current state of an environment in which a learning target exists while observing the current state and some kind of reward is given to the action, and learning a measure, that maximizes a total reward, as an optimal solution.

An example of an algorithm of the reinforcement learning executed by the learning unit 150 will be described. The algorithm according to this example is known as Q-learning, and is a method of using a state s of an action subject and an action a that the action subject can select in the state s as independent variables, and learning a function Q(s, a) representing a value of the action when the action a is selected in the state s. The optimal solution is to select the action a in which the value function Q is the highest in the state s. By starting the Q-learning in a state where a correlation between the state s and the action a is unknown and repeating trial and error to select various actions a in an optional state s, the value function Q is repeatedly updated to approach to the optimal solution. Here, when the environment, that is, the state s changes as a result of selecting the action a in the state s, a reward r, that is, a weighting of the action a corresponding to the change can be obtained, and by guiding learning such that the action a is selected in which a higher reward r is obtained, the value function Q can be approached to the optimal solution in a relatively short time.

An update formula of the value function Q can be generally represented as the following mathematical expression (1).

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

In the above mathematical expression (1), sₜ and aₜ are a state and an action at a time point t, respectively, and the state changes to sₜ₊₁ depending on the action aₜ. rₜ₊₁ is a reward obtained by changing the state from sₜ to sₜ₊₁. A term of maxQ means Q when the action a, which is considered at the time point t to maximize the value Q at a time point t+1, is performed. α and γ are a learning coefficient and a discount rate, respectively, and are optionally set such that 0<α≤1 and 0<γ≤1.

When the learning unit 150 executes the Q-learning, a state variable S, that is, the first data, and determination data D, that is, the manufacturing error data, correspond to a states of the update expression, an action of how to determine the target shape of the additional portion AP to be added to the target shape of the main body portion MP in the current state corresponds to an action a of the update expression, and a reward R required by the reward calculation unit 151 corresponds to a reward r of the update expression. Therefore, the value function update unit 152 repeatedly updates the function Q representing the value of the target shape of the additional portion AP added to the target shape of the main body portion MP in the current state by Q learning using the reward R.

The reward R obtained by the reward calculation unit 151 can be set as, for example, a positive reward R when a manufacturing error of the three-dimensional shaped object OB manufactured based on a determined target shape after the target shape of the additional portion AP is determined is smaller than the manufacturing error of the three-dimensional shaped object OB before changing, or when the manufacturing error of the three-dimensional shaped object OB manufactured based on the determined target shape is within the allowable range, and can be set as a negative reward R when the manufacturing error of the three-dimensional shaped object OB manufactured based on the determined target shape after the target shape of the additional portion AP is determined is larger than the manufacturing error of the three-dimensional shaped object OB before changing, or when the manufacturing error of the three-dimensional shaped object OB manufactured based on the determined target shape exceeds the allowable range.

When the Q-learning is advanced using the reward R corresponding to the manufacturing error of the manufactured three-dimensional shaped object OB, the learning is guided in a direction of selecting an action that gives a higher reward R, and according to a state of the environment that changes as a result of executing the selected action in the current state, that is, the state variable S and the determination data D, the value of an action value for the action performed in the current state, that is, the function Q is updated. By repeating this update, the function Q is rewritten such that the more appropriate the action is, the larger the value is. In this way, the correlation between the current state of an unknown environment and an action for the state is gradually clarified.

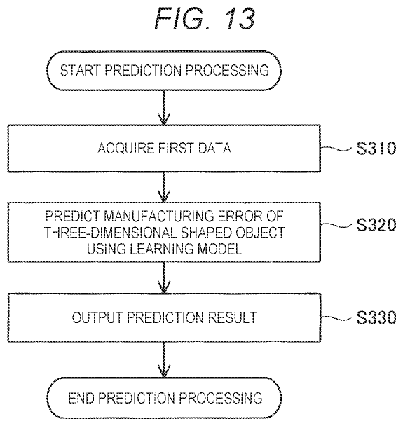

FIG. 13 is a flowchart showing contents of the prediction processing. This processing is executed by the machine learning device 100 when a predetermined start command is supplied to the machine learning device 100. First, in step S310, the data acquisition unit 110 acquires the first data. The acquired first data is stored in the data storage unit 120. In step S320, the prediction unit 170 reads the first data stored in the data storage unit 120 and the learning model stored in the learning model storage unit 160, predicts the manufacturing error of the three-dimensional shaped object OB manufactured based on the first data, and generates prediction result data showing a prediction result. The prediction unit 170 can predict, by using the value Q calculated by reading the first data and the learning model, the manufacturing error of the three-dimensional shaped object OB manufactured based on the first data. In the prediction result data, for example, the symbol “A” is shown to indicate that the manufacturing error of the three-dimensional shaped object OB manufactured based on the first data is within the allowable range, or the symbol “B” is shown to indicate that the manufacturing error of the three-dimensional shaped object OB manufactured based on the first data exceeds the allowable range. In the prediction result data, an amount of the manufacturing error or the like may be shown. In step S330, the prediction unit 170 ends this processing after the prediction result data is output to the display device 600.

According to the machine learning device 100 in the present embodiment described above, in the learning processing, the learning unit 150 generates the learning model that can predict the manufacturing error of the three-dimensional shaped object OB, and in the prediction processing, the prediction unit 170 predicts whether the manufacturing error of the three-dimensional shaped object OB is within the allowable range using the learning model, and outputs the prediction result to the display device 600. Therefore, when the prediction result that the manufacturing error of the three-dimensional shaped object OB exceeds the allowable range is output, a user can modify the target shape of the additional portion AP such that the manufacturing error of the three-dimensional shaped object OB is within the allowable range, so that the three-dimensional shaped object OB can be manufactured with high dimensional accuracy.

Further, in the present embodiment, the learning data set includes the material data. Therefore, it is possible to generate the learning model that can predict the manufacturing error of the three-dimensional shaped object OB according to the material to be used in the shaping step.

In the present embodiment, the learning data set includes the heat treatment condition data. Therefore, it is possible to generate the learning model that can predict the manufacturing error of the three-dimensional shaped object OB according to the heat treatment conditions in the heat treatment step.

### B. Second Embodiment

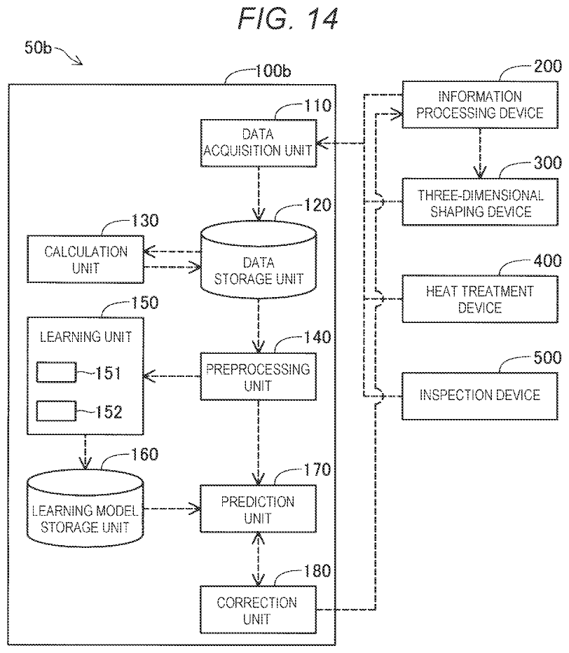

FIG. 14 is an explanatory diagram showing a schematic configuration of a machine learning system 50b according to a second embodiment. The machine learning system 50b in the second embodiment is different from that of the first embodiment in that a machine learning device 100b includes a correction unit 180 that corrects the additional shape data according to the prediction result of the prediction unit 170, and contents of the prediction processing executed by the machine learning device 100b are different. Other configurations are the same as those of the first embodiment shown in FIG. 1 unless otherwise specified.

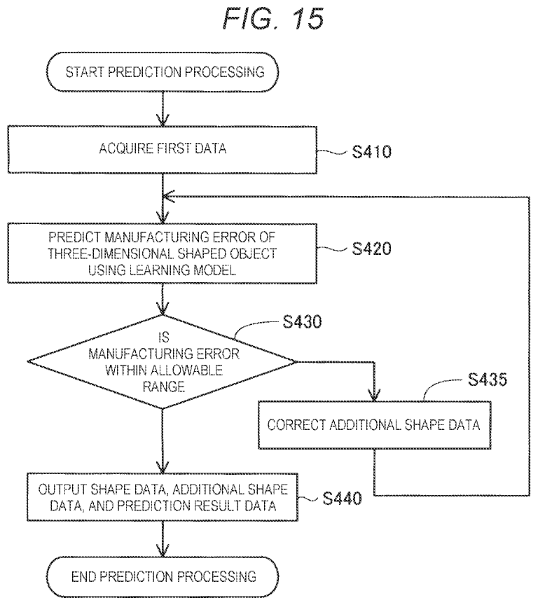

FIG. 15 is a flowchart showing the contents of the prediction processing according to the present embodiment. Contents of the processing in steps S410 and S420 are the same as the contents of the processing in step S310 and step S320 of the prediction processing of the first embodiment shown in FIG. 13. In step S430, the correction unit 180 determines whether the manufacturing error of the three-dimensional shaped object OB manufactured based on the first data is within the allowable range. The correction unit 180 uses the prediction result data generated by the prediction unit 170 in step S420 to determine whether the manufacturing error of the three-dimensional shaped object OB manufactured based on the first data is within the allowable range.

When it is determined in step S430 that the manufacturing error of the three-dimensional shaped object OB manufactured based on the first data is not within the allowable range, in step S435, the correction unit 180 corrects the target shape of the additional portion AP represented by the additional shape data included in the first data. Correcting the target shape of the additional portion AP means not only changing the shape of the additional portion AP that is targeted at the time of manufacturing the three-dimensional shaped object OB, but also changing the size, the number, the arrangement, or the like. Thereafter, the processing is returned to step S420, and the prediction unit 170 reads the first data in which the additional shape data is corrected and the learning model, predicts the manufacturing error of the three-dimensional shaped object OB manufactured based on the first data in which the additional shape data is corrected, and generates prediction result data showing a prediction result. The prediction unit 170 and the correction unit 180 repeat the processing in steps S435, S420, and S430 until it is determined in step S430 that the manufacturing error of the three-dimensional shaped object OB manufactured based on the first data is within the allowable range.

When it is determined in step S430 that the manufacturing error of the three-dimensional shaped object OB manufactured based on the first data is within the allowable range, this processing ends after the shape data, the additional shape data, and the prediction result data are output in step S440. In the present embodiment, the correction unit 180 outputs the shape data, the additional shape data, and the prediction result data to the information processing device 200.

According to the machine learning device 100b in the present embodiment described above, when the manufacturing error of the three-dimensional shaped object OB predicted by the prediction unit 170 exceeds the allowable range, the correction unit 180 corrects the target shape of the additional portion AP represented by the additional shape data, and outputs the shape data, the corrected additional shape data, and the prediction result data. Therefore, by manufacturing the three-dimensional shaped object OB using the shape data and the corrected additional shape data, the manufacturing error of the three-dimensional shaped object OB can be prevented from exceeding the allowable range. When the deformation amount due to the heat of the three-dimensional shaped object including through holes or recesses is predicted by using the finite element method, boundary conditions set in the analysis model become complicated, so that accurate prediction is difficult. In the machine learning device 100 of the present embodiment or the machine learning device 100b of the first embodiment, since the deformation amount due to the heat of the three-dimensional shaped object is predicted by using the machine learning instead of the finite element method, the manufacturing error of the three-dimensional shaped object including through holes or recesses can be effectively prevented from exceeding the allowable range.

### C. Other Embodiments

(C1) In the machine learning device 100 or 100b of each of the above embodiments, the algorithm of the machine learning executed by the learning unit 150 in the learning processing is the reinforcement learning. On the other hand, the algorithm of the machine learning executed by the learning unit 150 in the learning processing may be the supervised learning. For example, in the learning processing, the learning unit 150 may execute the supervised learning using learning data set including a normal label indicating that the manufacturing error of the three-dimensional shaped object OB is within the allowable range, and an abnormal label indicating that the manufacturing error of the three-dimensional shaped object OB exceeds the allowable range, and may generate a discriminant boundary between normal data and abnormal data as the learning model. In this case, in the prediction processing, the prediction unit 170 uses the learning model to determine whether the read first data belongs to the normal data or the abnormal data, in other words, predicts whether the manufacturing error of the three-dimensional shaped object OB manufactured based on the read first data is within the allowable range.

(C2) In the machine learning device 100 or 100b of each of the above embodiments, the algorithm of the machine learning executed by the learning unit 150 in the learning processing is the reinforcement learning. On the other hand, the algorithm of the machine learning executed by the learning unit 150 in the learning processing may be the unsupervised learning. For example, in the learning processing, the learning unit 150 may execute the unsupervised learning using learning data set configured by data for the three-dimensional shaped object OB whose manufacturing error is within the allowable range, and may generate a distribution of the data for the three-dimensional shaped object OB whose manufacturing error is within the allowable range as the learning model. In this case, in the prediction processing, the prediction unit 170 can use the learning model to calculate how much the read data deviates from the data for the three-dimensional shaped object OB whose manufacturing error is within the allowable range, and calculate an abnormality degree as the prediction result.

(C3) In the machine learning system 50 or 50b of each of the above embodiments, the three-dimensional shaping device 300 is a binder jet type three-dimensional shaping device. On the other hand, the three-dimensional shaping device 300 may be a fused deposition modeling (FDM) type three-dimensional shaping device.

(C4) In each of the above embodiments, the additional portion AP added to the main body portion MP of the three-dimensional shaped object OB is inserted into the slit SL of the setter ST to prevent the deformation of the main body portion MP in the heat treatment step. On the other hand, the additional portion AP inserted into the slit SL of the setter ST may not be added to the main body portion MP. For example, a rod-shaped additional portion AP spanning an inner peripheral surface of the through hole or the recess may be added to the main body portion MP including the through hole or the recess.

### D. Other Aspects

The present disclosure is not limited to the embodiments described above, and can be implemented in various forms without departing from the scope of the present disclosure. For example, the present disclosure can be implemented by the following forms. In order to solve some or all of problems of the present disclosure, or to achieve some or all of effects of the present disclosure, technical characteristics in the above embodiments corresponding to technical characteristics in aspects described below can be replaced or combined as appropriate. In addition, when the technical characteristics are not described as essential in the present description, the technical characteristics can be deleted as appropriate.

(1) According to an aspect of the present disclosure, a machine learning device is provided. The machine learning device includes: a data acquisition unit configured to acquire first data including shape data representing a target shape of a three-dimensional shaped object and additional shape data representing a target shape of an additional portion to be added to the three-dimensional shaped object in order to prevent deformation of the three-dimensional shaped object during manufacturing, and second data related to the deformation of the three-dimensional shaped object; a storage unit configured to store a learning data set including a plurality of the first data and a plurality of the second data; and a learning unit configured to learn a relationship between the first data and the second data by executing machine learning using the learning data set.

According to the machine learning device of this aspect, the learning unit can generate, by the machine learning, a learning model that can predict the deformation of the three-dimensional shaped object.

(2) In the machine learning device according to the above aspect, the first data may include material data related to a material of the three-dimensional shaped object.

According to the machine learning device of this aspect, the deformation of the three-dimensional shaped object can be predicted even when the material is changed.

(3) In the machine learning device according to the above aspect, the first data may include heat treatment condition data related to a heat treatment condition for the three-dimensional shaped object.

According to the machine learning device of this aspect, the deformation of the three-dimensional shaped object can be predicted even when the heat treatment condition is changed.

(4) In the machine learning device according to the above aspect, the learning unit may execute, as the machine learning, at least one of supervised learning, unsupervised learning, and reinforcement learning.

According to the machine learning device of this aspect, the learning model can be generated by at least one of the supervised learning, the unsupervised learning, and the reinforcement learning.

(5) The machine learning device according to the above aspect may include: a prediction unit configured to predict the deformation of the three-dimensional shaped object using a learning model generated by the machine learning of the learning unit.

According to the machine learning device of this aspect, the deformation of the three-dimensional shaped object can be predicted using the learning model. Therefore, when the prediction result is not preferable, a user can change the target shape of the additional portion represented by the additional shape data.

(6) The machine learning device according to the above aspect may include: a correction unit configured to correct the additional shape data according to a prediction result of the prediction unit and output the corrected additional shape data.

According to the machine learning device of this aspect, the correction unit corrects the additional shape data according to the prediction result and outputs the corrected additional shape data. Therefore, by manufacturing the three-dimensional shaped object using the output additional shape data after the correction, the three-dimensional shaped object can be manufactured with high dimensional accuracy.

The present disclosure can also be implemented in various forms other than the machine learning device. For example, the present disclosure can be implemented in forms of a machine learning system, a method of predicting a manufacturing error of a three-dimensional shaped object, or the like.

What is claimed is:

1. A machine learning device, comprising:
a data acquisition unit configured to acquire first data including shape data representing a target shape of a three-dimensional shaped object and additional shape data representing a target shape of an additional portion to be added to the three-dimensional shaped object in order to prevent deformation of the three-dimensional shaped object during manufacturing, and second data related to the deformation of the three-dimensional shaped object;
a storage unit configured to store a learning data set including a plurality of the first data and a plurality of the second data; and
a learning unit configured to learn a relationship between the first data and the second data by executing machine learning using the learning data set.

2. The machine learning device according to claim 1, wherein
the first data includes material data related to a material of the three-dimensional shaped object.

3. The machine learning device according to claim 1, wherein
the first data includes heat treatment condition data related to a heat treatment condition for the three-dimensional shaped object.

4. The machine learning device according to claim 1, wherein
the learning unit executes, as the machine learning, at least one of supervised learning, unsupervised learning, and reinforcement learning.

5. The machine learning device according to claim 1, comprising:
a prediction unit configured to predict the deformation of the three-dimensional shaped object using a learning model generated by the machine learning of the learning unit.

6. The machine learning device according to claim 5, further comprising:
a correction unit configured to correct the additional shape data according to a prediction result of the prediction unit and output the corrected additional shape data.
